(19) United States
(12) Patent Application Publication
(10) Pub. No.: US 2013/0210412 A1
(43) Pub. Date: Aug. 15, 2013

(54) METHOD FOR EMBEDDING DEVICE-SPECIFIC DATA TO ENABLE PROVISIONING A DEVICE WITH A MOBILE DEVICE

(71) Applicant: Logic PD, Inc., (US)

(72) Inventors: Kurt T. Larson, Plymouth, MN (US); Eugen Feraru, Prior Lake, MN (US); Michael Tilstra, Apple Valley, MN (US); Mark Benson, Playmouth, MN (US); Matthew Tilstra, Rogers, MN (US); Matthew Hilden, Robbinsdale, MN (US); Nick Klein, Coon Rapids, MN (US); Scott A. Nelson, Eagan, MN (US)

(73) Assignee: Logic PD, Inc., Eden Prairie, MN (US)

(21) Appl. No.: 13/739,354

(22) Filed: Jan. 11, 2013

Related U.S. Application Data
(60) Provisional application No. 61/640,162, filed on Apr. 30, 2012.
(60) Provisional application No. 61/586,439, filed on Jan. 13, 2012.
(60) Provisional application No. 61/586,368, filed on Jan. 13, 2012.
(60) Provisional application No. 61/586,385, filed on Jan. 13, 2012.

(51) Int. Cl. H04W 8/18

(52) U.S. Cl. CPC H04W 8/18
USPC 455/418

(57) ABSTRACT

The invention provides methods for providing a unified single-scan user interface for accessing and managing a remotely located device throughout its life cycle, including cellular network provisioning, cloud data provider registration, initialization and activation, as well as providing end users with easy access to the device and its data. The end user simply powers the device on and the device automatically connects with the communication network and the cloud data provider. The device comes to the end user already provisioned and paired and activated with the cloud data provider and the communication network provider. The end user may provision the device by scanning an optically scannable identification label having device-specific data embedded thereon using a mobile device such as a smartphone or the like.

### RELATED APPLICATION

This application claims the benefit of U.S. Patent Provisional Application Nos. 61/586,368, 61/586,385 and 61/586,439 filed Jan. 13, 2012, and 61/640,162 filed Apr. 30, 2012, the entire contents of each of which are hereby incorporated by reference.

### BACKGROUND OF THE INVENTION

1. Field of the Invention

The invention relates generally to systems, devices and methods for improved provisioning, automatic network joining and easy access and management of remotely networked devices.

2. Description of the Related Art

Machine-to-Machine (M2M) communication device provisioning and device setup is quite complex today, with limited functionality, from an end user perspective. Generally, known systems require the end user to interact with each node, manually provision with a data service, manually establish user and security credentials, and manually connect with a data repository or database. Simplification of this process is one of several objectives of the present invention.

Systems and methods exist that use unique device information encoded on labels, e.g., quick response (QR) codes for providing interactive applications and services to a user via, e.g., mobile devices. Known mobile devices such as a smartphone comprise a scanner to scan the QR code of the labeled object. Typical applications use the QR code or data or the QR code to direct to a specific URL. QR codes are currently used in broader contexts spanning commercial tracking applications, such as tracking parts in vehicle manufacturing processes, and convenience-oriented applications targeting mobile device users. See U.S. Pat. No. 5,726,435 for disclosure of two-dimensional optically readable codes, the entire contents of which are hereby incorporated by reference.

Other machine-readable labels, i.e., scannable codes, relating to an information topic about a particular product or device exist. For example, bar codes, Microsoft TAG or other label on a device comprising unique device information are known in the art.

The types of information typically encoded on known machine-readable labels may comprise data such as serial number(s) or other unique identification data for a product, device and/or individual components or subcomponents, Media Access Control (MAC) address, and the like.

Known exemplary solutions are in U.S. Pat. No. 7,055,737 to Tobin, US application 2009/0287498 to Choi, U.S. Pat. No. 7,779,125 to Wyngarden and U.S. Pat. No. 7,912,426 to Masera, the disclosures of which are hereby incorporated in their entirety.

What is not known in the art are systems or methods that provide, inter alia, a unified single-scan user interface for accessing and managing a remotely located device throughout its life-cycle, including cellular network provisioning, cloud-data provider registration, initialization and activation, as well providing end users easy data access relating to the device.

### BRIEF SUMMARY OF THE INVENTION

The invention provides methods for providing a unified single-scan user interface for accessing and managing a remotely located device throughout its life cycle, including cellular network provisioning, cloud data provider registration, initialization and activation, as well as providing end users with easy access to the device and its data. The end user simply powers the device on and the device automatically connects with the communication network and the cloud data provider. The device comes to the end user already provisioned and paired and activated with the cloud data provider and the communication network provider. The end user may provision the device by scanning an optically scannable identification label having device-specific data embedded thereon using a mobile device such as a smartphone or the like.

The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 is a schematic of one embodiment of the present invention;

FIG. 2 is a schematic of one embodiment of the present invention;

FIG. 3 is a flow diagram of one embodiment of the present invention;

FIG. 4 is a flow diagram of one embodiment of the present invention;

FIG. 5 is a flow diagram of one embodiment of the present invention;

FIG. 6 is a schematic of one embodiment of the present invention;

FIG. 7 is a flow diagram of one embodiment of the present invention;

FIG. 8 is a schematic of one embodiment of the present invention;

FIG. 9 is a flow diagram of one embodiment of the present invention;

FIG. 10 is a schematic of one embodiment of the present invention.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

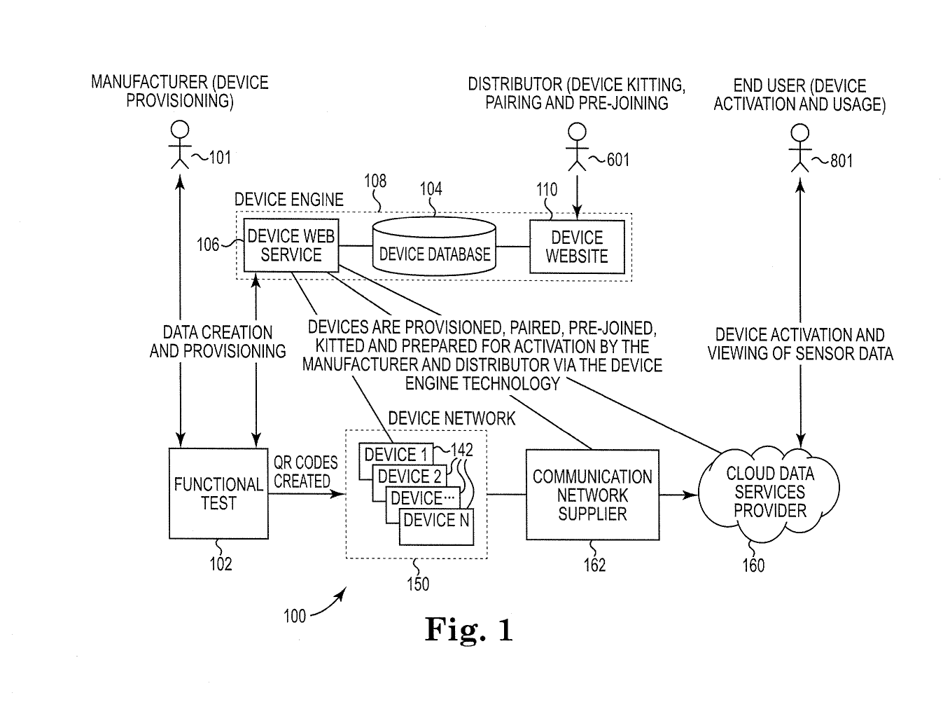

FIG. 1 illustrates a system level diagram of one embodiment of the present invention. The inventive system 100 begins with manufacture of at least one exemplary manufactured device, e.g., a sensor without limitation, at a manufacturing facility 101.

“Device” as that term is used herein is defined as a structure that communicates between two or more networks and may comprise gateways, nodes and that may be controlled or monitored remotely including, without limitation, monitoring conditions such as with a sensor, controlling functionality and device characteristics, and actuating or de-actuating device functionality(ies).

The exemplary system 100 comprises a manufacturing software tool as is well known to the skilled artisan and which performs functional testing 102 on an exemplary manufactured device such as, without limitation, a sensor device, at the site of the manufacturer 101 of the device. The manufacturing tool's functional testing 102 comprises testing of the function of the exemplary manufactured device as well as the capability of adding the manufactured device to a device database 104 via a device web service 106. The device database 104 and device web service 106 are, as illustrated, located within a device engine 108.

The functional test 102 comprises actual device testing, e.g., in the exemplary case of a temperature sensor testing is conducted to determine the sensitivity and range, e.g., of the device as well as the functionality of the device's radio modem or other network connectivity mechanism. In addition, the functional test 102 comprises registration or addition of the device's identification data, including unique data such as the device's serial number, as well as non-unique data, if present, to the device database 104 via the device web service 106 of the device engine 108. In addition to the serial number of the device, the functional test 102 may also register or add additional device identification data, such as model type or number, and/or radio modem address and/or mobile equipment identifier (MeID), as well as the unique identifier mapped to the QR code.

The device web service 106 is in operative communication with the manufacturing tool and with the functional test 102 and receives thereby the results of the functional testing 102, in addition to one or more servers which are well known in the art and therefore not shown in the illustration. In addition, the device engine 108 comprises a device website 110 in operative communication with the device database 104 which is, in turn, in operative communication with the device web service 106. Device website 110 comprises a webpage to which the identification label, e.g., a QR code, resolves when scanned as is well known in the art. Device website 110 has a webpage URL encoded by the exemplary QR code to which the QR code resolves to as well known in the art once scanned by a distributor 601 or customer, end user 801 with, e.g., a smartphone or other similar device having scanning capabilities and connectivity to the Internet.

Initially, the device's status at this stage of manufacture is Unassigned as it relates to the cloud data provider 160 and Unassigned as it relates to its communication network supplier 162. As defined herein, communication network supplier may supply communications comprising one or more of the following categories:

(1) wide area networks (WAN) comprising, for example and without limitation, wireless cellular networks and network providers and/or satellite uplinking networks and network providers;

(2) local area networks (LAN) comprising, for example and without limitation, wifi networks and network providers;

(3) personal area networks (PAN) comprising, for example and without limitation, Bluetooth networks and Bluetooth network providers and Near Field Communications (NFC) networks and NFC network providers, as well as ZigBee/802.15.4 as an exemplary communication class; and

(4) Ethernet.

The several states of the device and the transitions from state-to-state are described in further detail herein.

Once the exemplary manufactured device's information is added to the device database 104, the manufacturer then initiates generation of the identification label, in the illustrated case a QR code, for the device being manufactured. The QR code may contain unique and, in some case, non-unique data obtained during the manufacturing process and based on the identifier data provided to the device database 104 by the functional test process 102, via device web service 106. A preferred, but certainly not limiting, unique identifier data element for encoding on the QR code is the exemplary manufactured device's serial number.

The QR code may, in some cases, be assigned additional data as the device progresses through the later steps of distribution kitting and device activation.

The device engine 108, comprising device web service 106, device database 104 and device website 110, is in operative communication with, inter alia, the communication network provider 162 and the cloud data service provider 160 via operative communication with device web service 106 and the communication network provider 162 and cloud data service provider 160.

When the device is registered, or added to, the device database 104 via the device web service 106, by manufacturer 101, a scheduled job is provided in order to register or provision the device with the cloud data service provider 160 wherein the device engine 108, via device web service 106, instructs the cloud data provider 160 to add the exemplary manufactured device as, e.g., a serial number or other unique identifier. If registration or addition of the device's serial number or other unique identifier with the cloud data service provider 160 is successful, the device's status relative to the cloud data provider 160 moves from Unassigned to Assigned as Serial Number. This process occurs while the device is still within the factory or manufacturing facility 101.

The factory provisioning process concludes with provisioning of the exemplary manufactured device with both the cloud data provider 160 and the communication network provider 162. Thus, the device database 104 of device engine 108 also automatically activates, then suspends, the device's network radio modem by negotiating with the communication network provider 162. After successful negotiation with the communication network provider 162 in this activity, the device's network radio modem status, i.e., its network state, with the communication network provider 162 moves from Unassigned to Network Activated, then to Network Suspended pending action by the distributor 601 and the end user or customer 801. The device engine 108 coordinates and drives the factory provisioning process with the cloud data provider 160 and the communication network provider 162.

At this point, the device is factory provisioned and ready for further processing through the distributor 601 once an order from the end user or customer 801 is received. The device may remain at the manufacturer's factory facility until a customer order is received, at which point the device is transferred to the distributor 601. Alternatively, once the device is manufactured and the factory provisioning is complete, the device may be transferred to the distributor 601 to be stocked while waiting a customer or end user 801 order.

Generally, as illustrated in FIG. 1, once a customer or end user 801 order is received, the distributor 601 will initiate distribution kitting by scanning the identification label, e.g., the QR code previously developed and affixed to, and embedded within, the device. As discussed and as is known in the art, the QR code encodes a URL that comprises the device's identifier information, e.g., the device's serial number. Thus, when scanned by, e.g., a mobile device with scanning capability, e.g., a smartphone or the equivalent, the QR code resolves to a webpage on the device engine website 110 with a pointer to, e.g., the device's serial number. This webpage within device website 110 may also cause actions to be taken based on the device's status and provide feedback to the user 801.

As stated supra, when the distributor 601 first scans the device's QR code, the device pairing and activation activities are initiated relating to the communication network provider 162 and the cloud data service provider 160, taking advantage of the device's status following the factory provisioning process. The distribution kitting process is discussed further below.

Once the distribution kitting process is completed by the distributor, the device is activated with the communication network provider 162 and paired and activated with the cloud data service provider 160, the device's status is active with both the communication network provider 162 and with the cloud data services provider 160. A primary advantage is the resulting simplicity for the customer or the end user 801 who will only need to power the device on in order to enable the activated device 142 to automatically join the network and access relevant data.

Following shipment by the distributor of the activated device 142 to the user 801, the user 801 need only power the device 142 on. The activated device 142 may be a single networked device or may be one of several devices within, or added to, a device network 150 comprising more than one networked device. Each networked device, and the device network, is in operative communication with the device engine 108, including the device engine website 110, the device database 104, the device web service 106, the cloud data services provider 160, and the communication network provider 162. Thus, the activated device 142 and/or device network 150 may transmit and receive data from the device engine's website 110 and the cloud data services provider 160 to end user 801.

The activated device 142 may automatically connect with the communication network provider and the cloud data provider on the initial power up and/or each successive power up in certain embodiment of the present invention.

As a result, if, for example, and as illustrated, the customer or end user 801 wishes to scan the QR code specific for the activated device 142, or otherwise access the QR code embedded therein, the customer or user 801 may view the relevant data of the activated and operational device 142. In the exemplary case, the device 142 is, in addition to the definition of “device” provided above, a sensor, e.g., a temperature or humidity sensor, though many other devices are contemplated and within the scope of the present invention. In addition, other types of devices that may be manufactured and distributed to enable automatic joining of a network upon powering on comprise sensors for monitoring one of the group consisting of: tank level, liquid leakage, movement, speed (accelerometer) and vibration as are well known to the artisan. In addition, other types of devices amenable to the inventive system and methods described herein will readily present themselves to the skilled artisan. For example, and without limitation, devices amenable to the inventive system and methods described herein include devices for measuring distance, sound, pressure, voltage, current, speed, position, velocity, acceleration, weight, wavelength, frequency, period, duty cycle as well as determining whether a switch or circuit is open or closed. Each such device is within the scope of the inventive system and method.

Thus, generally, the present invention requires the subject product or device to be marked and/or embedded with unique encoded data, captured during the specific device's manufacturing process, to assist in identifying the particular product or device during the inventive process. Identification labels, for example and without limitation QR codes, Microsoft TAG solutions may be employed for this purpose.

Exemplary types of unique data that may be captured during the manufacturing process and used to populate the identification labels, e.g., QR code, comprise: Serial number(s) for the particular device or product, components or subcomponents thereof, identification data, media access control address (MAC), international mobile equipment identity (IMEI) data, subscriber identity module (SIM), machine-to-machine (M2M) identity module (MIM) data. Further, non-unique data may be encoded on an identification label, and/or embedded within the product or device such as, without limitation, product family identities, product data, brand data and fixed or variable uniform resource locator(s) (URL) data.

As discussed, FIG. 1 illustrates one embodiment of the present invention at a general system level. There are three basic component systems within the inventive system:

Manufacturing where device provisioning occurs;

Distribution, where device kitting, pairing and pre-joining occurs; and

End user, where device activation and use occurs.

Each of these three basic component systems comprising inventive system 100 will be discussed now in more detail.

Manufacturing Device Provisioning:

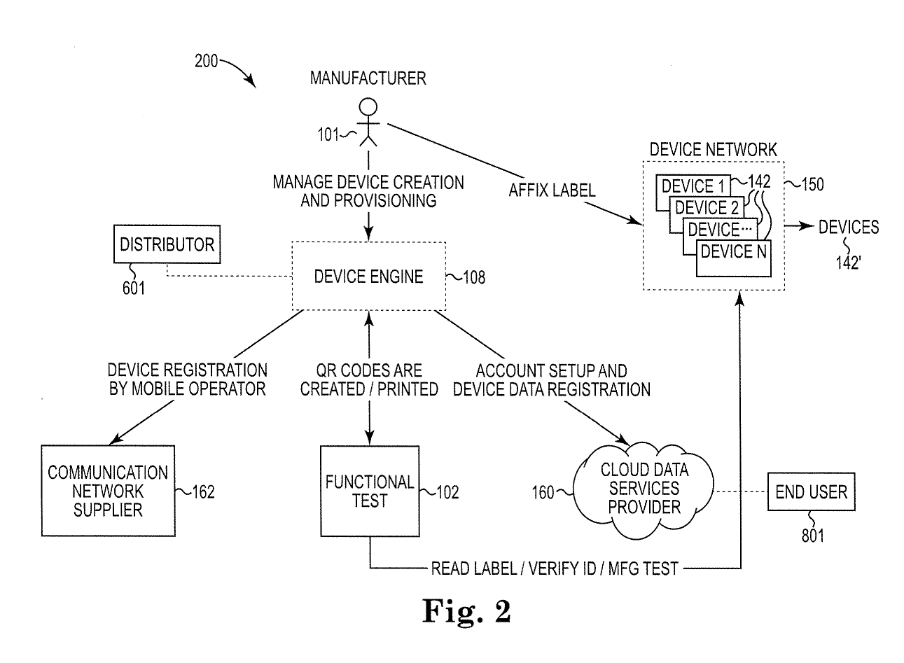

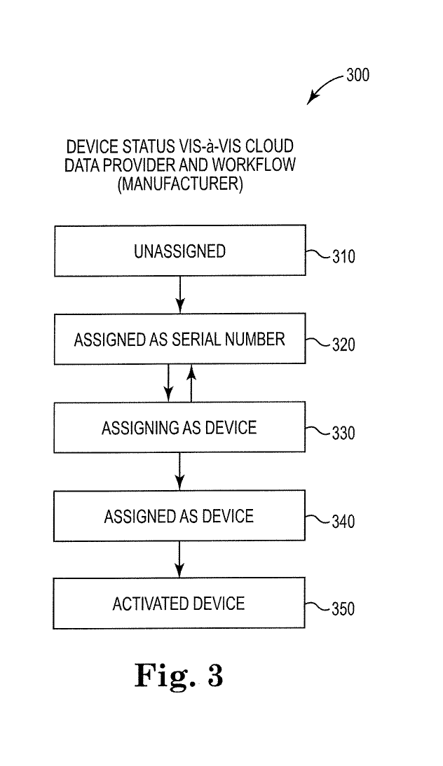

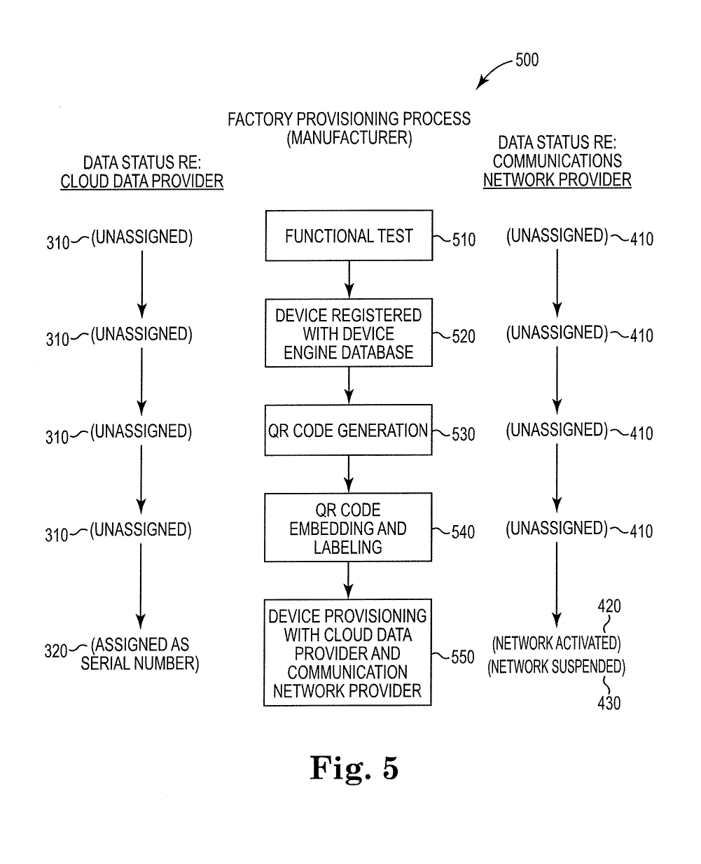

FIG. 2 thus illustrates one embodiment of the creation of the exemplary device and provisioning of that device by the manufacturer. We also refer to FIGS. 3, 4 and 5 which illustrate the states of the exemplary manufactured device in the provisioning process relating to the cloud data provider 160 and the cellular network provider 162.

With reference to FIGS. 1, 2 and 3, the exemplary device is, under the present invention, in one of the following five states 300 relative to the cloud data provider 162 at all times:

1. Unassigned 310. The unassigned state 310 is the state existing before, and during, the adding of the device into the device engine database 104 within device engine 108 as discussed above and which, when complete, triggers a pending request for subsequent registration of the device with the cloud data provider 160.

2. Assigned As Serial Number 320. The assigned-as-serial-number state 320 occurs when the device's serial number is registered with the cloud data provider 160. Thus, this state occurs following the establishment of the unassigned state 310 and execution of the pending request for registration of the device with the cloud data provider 160. If the device's serial number is unable to be registered with the cloud data provider 160 for any reason, the device's status returns to unassigned 310.

3. Assigning As Device 330. The assigning-as-device state 330 occurs as the device is being registered as a device during the distributing kitting process. A device enters this state by having its identification label, e.g., QR code, scanned for the second time. Such second scan of the exemplary QR code is performed by the distributor 601 during the distribution kitting process which will be discussed in greater detail below. Assigning As Device 330 is a transient state, dependent upon the success of the registration of the device; typically a device will remain in this state no longer than a few seconds.

4. Assigned As Device 340. The assigned-as-device state 340 occurs when the device is successfully registered with the cloud data provider 160. A device enters this state when the cloud data provider 160 provides a notification to the device engine 108 of the assigning-as-device 330 activity.

5. Activated Device 350. The activated state 350 occurs when the device has (1) been activated with the cloud data provider 160 and (2) its unique device identifying data is entered into the device database 104 within device engine 108.

The Unassigned 310 and Assigned-as-Serial-Number 320 states occur at the manufacturing site during a factory provisioning process. The remaining states, i.e., Assigning-as-Device 330, Assigned-as-Device 340 and Activated Device 350 states are initiated and completed by the distributor 601 or, alternatively, by the end user 801.

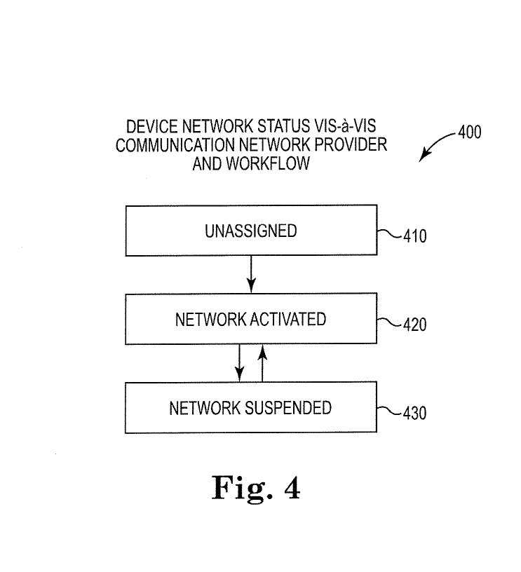

The device in the present invention also comprises a radio modem as is well known in the art and which is always in one of three states 400 as illustrated in FIG. 4, with continued reference to FIGS. 1 and 2:

1. Unassigned 410. The device's radio modem is in the unassigned state 410 when the device is added to the device database 104 within device engine 108 by the manufacturer 101.

2. Network Activated 420. The device's radio modem is in the network-activated state 420 after the data plan is activated through the communication network provider 162. This occurs immediately after successful addition of the device to the device database 104 of the device engine 108 by the manufacturer 101.

3. Network Suspended 430. The device's radio modem is suspended in the network-suspended state 430. This suspension occurs immediately after successful network activation and is performed by manufacturer 101.

As discussed briefly above, the exemplary manufactured device is provisioned during its manufacturing process, referred to herein as factory provisioning 500 as illustrated in FIGS. 1, 2 and 5, with continued reference to FIGS. 3 and 4. This process transforms a newly manufactured device into a fully network-activated device that is correctly configured to report data to the cloud data provider 160.

Factory provisioning 500 thus comprises a functional test process 510 which, inter alia, registers, or adds, the device with/to the device database 104 as shown in FIG. 1. The functional test process 510 registers the device's unique identifier data, e.g., serial number, model and/or radio modem address into the device database 104 in step 520. Initially, the device state as it relates to the cloud data provider 160 is Unassigned 310 and its radio modem network state is also Unassigned 410 as it relates to the communication network provider 162.

The manufacturer 101 next initiates generation of the QR code, or other labeling mechanism such as Microsoft TAG as described above in step 530. The QR code may be printed and affixed to the device for future scanning and data transmission and reception 540. The QR code is further embedded within the device to enable future communication and data transmission and reception 540. The functional test process embeds the QR code in the device. This allows the device, once deployed in the field, to query the device database 104 for its unique cloud data provider identifier, referred to hereinafter as “CIK”, and which will be obtained during the device's distribution kitting process described in detail below.

The QR code is generated by the device database based on the unique identifier data provided to the device database 104 by the functional test process 510. The QR code may, preferably will, be assigned further data as the device progresses beyond manufacturing 101 through distribution kitting and device activation.

Registration, or addition, of the device with the device database 104 within device engine 108 also queues the device to be registered with the cloud data provider 160. A scheduled job is provided which automatically handles device provisioning with the cloud data provider 160.

The factory provisioning process 500 concludes with the device provisioning with both the cloud data provider 160 and the communication network provider 162 in step 550 and proceeds in two phases. First, device provisioning with the cloud data provider 160 occurs when the device engine 108 instructs the cloud data provider 160, via an automatic scheduled job, to add the device as a serial number to the cloud data provider's database records. If the serial number is successfully added to the cloud data provider 160, the device's status relative to the cloud data provider 160 after provisioning moves from Unassigned 310 to Assigned as Serial Number state 320. The device engine 108 also activates, and suspends, the network modem of the device by negotiating with the communication network provider 162. Thus, the device's radio modem state, i.e., its network state, with the communication network provider 162 moves from Unassigned 410, to Network Activated 420 and Network Suspended 430.

Distribution Kitting:

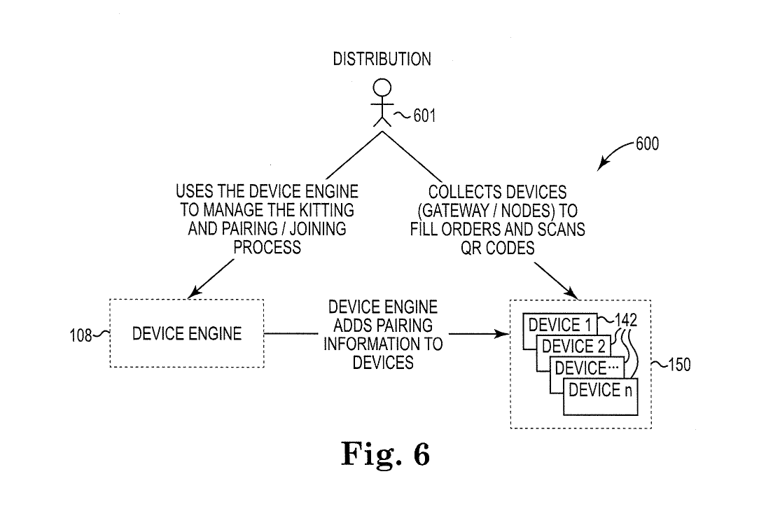

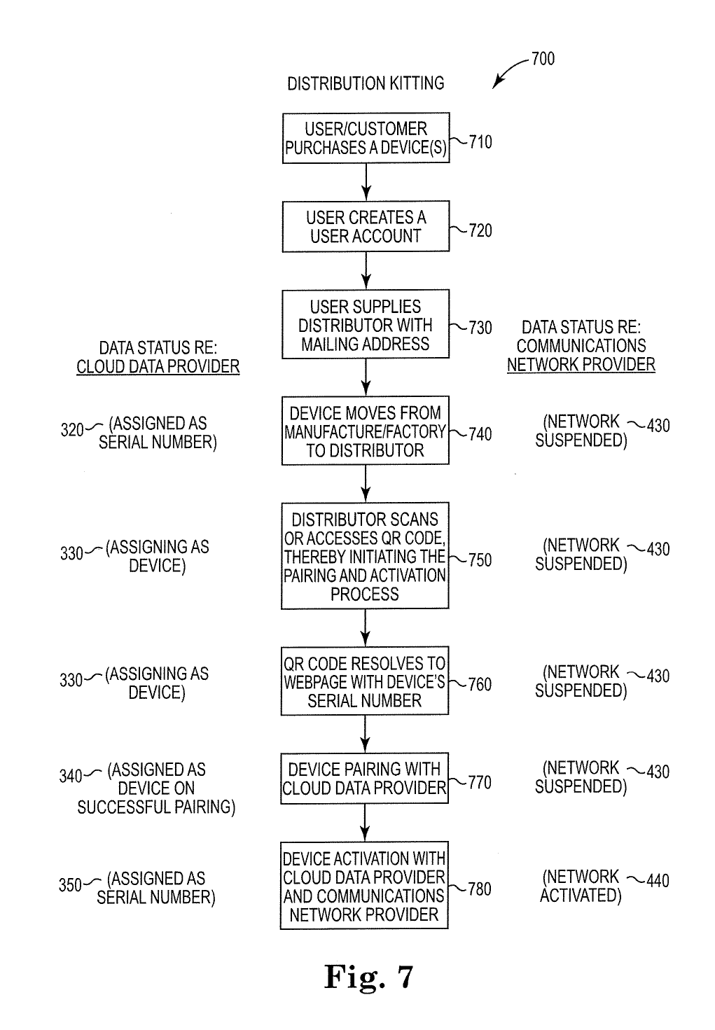

We now refer to FIG. 6, within continued reference to FIGS. 1-5 to describe the system level distribution kitting, pairing and pre-joining processes occurring at the distributor 601. Following the factory provisioning process described above, the exemplary manufactured device moves from the manufacturer 101 to the distributor 601 where, in response to a customer or end user 801, order, the distribution kitting process 600 occurs, which (1) pairs the device with a specific user account, (2) activates the device with the cloud data provider 160 and (3) activates the device with the communication network provider 162. Scanning the device's QR code is the primary method for transitioning the device from state to state through the distribution kitting process 600. FIGS. 6 and 7 illustrate one embodiment of this process 600, 700 in flow chart form.

The customer or end user 801, purchases a device which, as discussed above may comprise a gateway, from the distributor 601 in step 710 and creates a user account with the cloud data provider 160 in step 720. The distributor 601 only needs the customer's mailing address for shipment of the device 730 once the user account has been created.

Once an order is received by a customer 801 and a customer account created 710, 720, the device moves from the manufacturing facility or factory to the distributor 740. An alternative embodiment comprises shipping the device from the factory to the distributor 740 in bulk and the distributor 740 waits for a customer order to send off a single set, or sets, of devices. The distributor 601 then scans the identification label, e.g., QR code that is affixed on the device in step 750, thereby initiating the pairing and activating process. This QR code encodes a URL that includes the device's serial number. As discussed, the QR code, scanned by a device comprising well known software for this purpose, resolves to a webpage on the device engine website with a pointer to its serial number in step 760. This webpage will cause appropriate action(s) to be taken based on the status of the device and provide feedback to the user.

When the distributor first scans the device's QR code, the pairing and activating processes are initiated in step 750. By the time the end user receives the device after purchase, all that is require to access the data is to power on the device.

In this way, device pairing with the user's account with the cloud data provider is accomplished as part of the distribution kitting process 700 by scanning the device's QR code.

After this scan of the device's QR code and resolution of the QR code to the webpage with the device's serial number 750, 760, the device status relative to the cloud data provider 160 is moved from Assigned as Serial Number 320, as the device's state was following the factory provisioning process discussed above, to Assigning as Device 330. Assigning As Device 330 is a transient state, indicating that the software is negotiating with the cloud data provider 160. The cloud data provider 160 will indicate success or failure of process with a callback. If no response is received by the distributor 601 from the cloud data provider 160, the device's software reverts back to the Assigned as Serial Number state 320.

If the device is successfully paired with the user's account with the cloud data provider 160, the cloud data provider 160 will invoke a callback to the device engine 108 and the device's state moves to Assigned as Device 340. The device engine 108 will then instruct the cloud data provider 160 to (1) activate the device, and (2) obtain the device's unique cloud data provider identifier or CIK, an element well known in the art. The CIK is, as described above, stored in the device's engine database 104. If the activation of the device is successful, the device's state relative to the cloud data provider 160 changes from Assigned as Device 340 to Activated Device 350. If activation fails, the status of the device remains Assigned As Device 340 and the failure tracked.

The communication network provider 162 is also called by the distributor 601 to activate the device on the cellular wireless network, moving the device from Network Suspended 430 to Network Activated 420 as illustrated in the Figures.

The device is now ready to be shipped to the end user 801 for joining the device network and is fully provisioned and activated with respect to both the wireless network provider 162 and the cloud data service provider 160.

Device Activation and Network Joining by User:

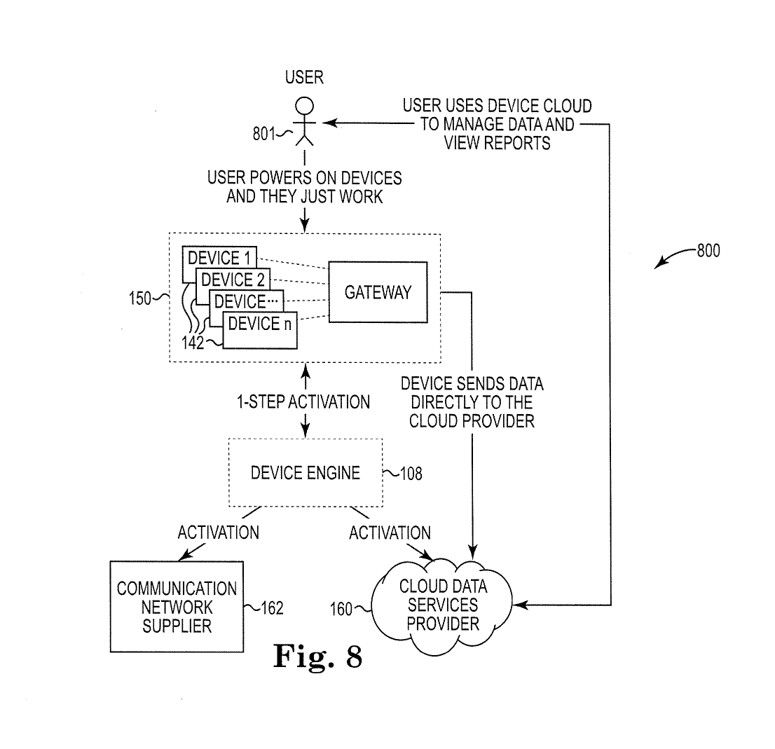

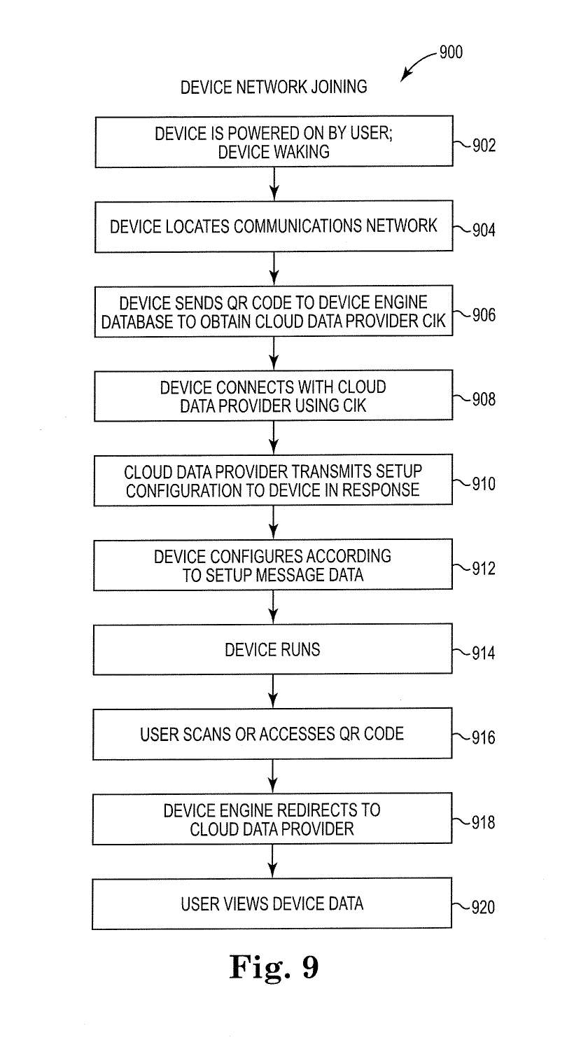

FIG. 8 illustrates one system level embodiment of the device activation and network joining process 800 while the process is illustrated in flow chart form in FIG. 9. When the device is powered on by user 801 and wakes up 902, it locates a gateway in its local wireless network 904 using techniques known to the skilled artisan. This allows the new device to join an existing gateway in the field. It is a possibility that the device may break up an existing pairing between it and a previous gateway in the field, based on signal quality.

Having obtained wireless, cellular, network connectivity via the gateway 904, the device connects to the device engine to obtain its cloud data provider CIK by sending its QR code to the cloud data provider 906, 908. These steps in the inventive process allows for the device to connect to the previously created user account with the cloud data provider 160, to which it was previously paired via the CIK during the distribution kitting process described above.

Thus, the device connects to the cloud data provider 160 using its cloud data provider CIK to retrieve its configuration message for setup 908. The cloud data provider 160 transmits in response a setup configuration message to the device 910. Based on the setup message transmitted from the cloud data provider 160 to the device, the device configures itself to conform with the setup message parameters and instructions 912. In the case of a remote sensing device, e.g., a temperature monitor, the temperature monitor is configured to conform with the parameters and instructions contained within the setup message such as maximum/minimum temperature, reporting frequency and other parameters dictating the type and frequency of the message being transmitted from the device to the cloud data provider 160. At this point the device is operational and runs within the network 914.

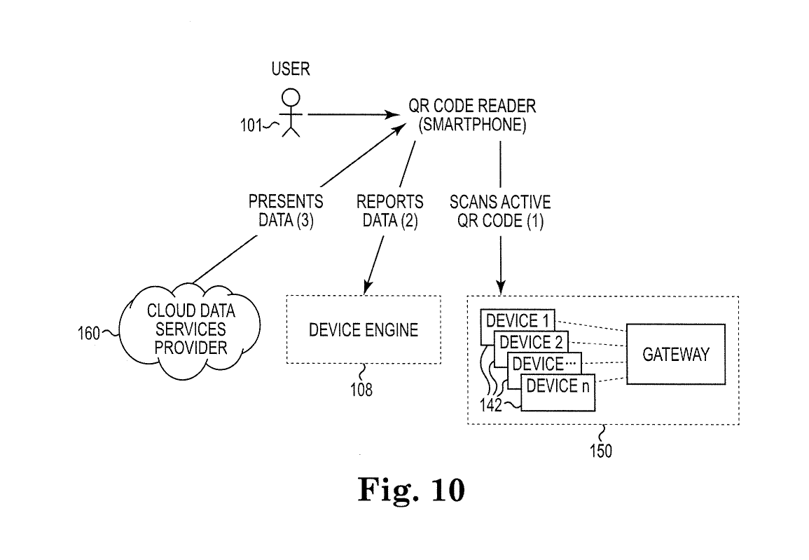

Once a device is activated, its QR code can still be scanned by, e.g., the customer or end user 801 in order to, inter alia, allow the end user 801 to obtain data from the device as illustrated in FIG. 10. In this case, the webserver will redirect its URL to the cloud data provider 160 in step 918 where the customer or end user may view its device's data 920.

The device of the inventive system and method may be of various types, e.g., gateway devices comprising both cellular network, e.g., CSMA, GSM, as well as local area wireless network, capabilities. The gateway devices provide connectivity to the device engine website as well as the cloud data provider, via the cellular network radio modem.

Another device embodiment may comprise sensor nodes which have only local area wireless network capabilities. Sensor node devices read sensor data and leverage the gateway devices, as pass through communications means, for connecting to the device engine website as well as the cloud data provider, via the cellular network radio.

The inventive manufacturing and distribution process enable pairing sensor node devices to gateways in the factory/manufacturing and distribution channel so that when the customer or end user powers the devices up they begin working without further interaction or steps required by the customer. Further, a customer may select both the number and type of sensor nodes at the time of purchase and the device engine will pair the purchased devices with the gateway during kitting. Thus, the customer may configure the sensor-gateway combination at the time of purchase yet only needs to power on and scan the devices to access the data.

In various embodiments of the present invention, it is possible to use a mobile device, e.g., a smartphone or other device having Internet access and scanning capability, to provision one or more devices manufactured according to the above disclosure. More specifically, product-specific information or data obtained at the point of manufacture for individual devices is captured and encoded on known machine-readable identification labels. Such identification labels may comprise, e.g., QR codes, Microsoft TAG solutions and the like.

Exemplary types of unique data that may be captured during the manufacturing process and used to populate the identification labels, e.g., QR code, comprise: Serial number(s) for the particular device or product, components or subcomponents thereof, identification data, media access control address (MAC), international mobile equipment identity (IMEI) data, subscriber identity module (SIM), machine-to-machine (M2M) identity module (MIM) data. Further, non-unique data may be encoded on an identification label, and/or embedded within the product or device such as, without limitation, product family identities, product data, brand data and fixed or variable uniform resource locator(s) (URL) data.

Under this embodiment of the present invention, the encoded information or data on the identification label may be also compiled in a table, wherein the table resides in a remote database accessible by internet via scanning an identification label with the remote device, e.g., a smartphone. The QR code, Microsoft TAG, or equivalent, once scanned, allows the user to view a URL, i.e., webpage, that allows the device associated with the scanned identification label to be provisioned remotely based on the specific encoded information. Such provisioning may comprise, without limitation, powering up whereby the remote device then automatically joins an end user's communication network and a cloud data services provider, automatically joins a device network and/or is in automatic communication with the communication network and cloud data services provider as discussed supra.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A method for providing a remote device that may be provisioned with a mobile device having internet access and scanning capability, comprising:
manufacturing a device with at least one network radio modem;
providing provisioning and activation of the device with a communication network provider during the manufacturing and distribution process;
providing provisioning and activating of the device with a cloud data services provider during the device manufacturing and distribution process;
providing pairing of a user's account relating to an end user with the cloud data services provider during the manufacturing and distribution process;
automatically joining the device with the cloud data services provider and the provisioned and activated communication network upon power up by the end user;
obtaining device-specific data for the manufactured device;
embedding the device-specific data obtained on an optically scannable identification label;
attaching the identification label to the manufactured device;
entering the device-specific data in a database;
scanning the identification label with the mobile device to obtain access to the manufactured device;
using the mobile device, powering up the accessed manufactured device; and
enabling automatically joining the accessed manufactured device with a device network.

2. The method of claim 1, wherein the communication network comprises one of the group consisting of wide area network, local area network, personal area network and ethernet network.

3. The method of claim 2, wherein the wide area communication network comprises a wireless cellular network and/or a wifi network.

4. The method of claim 2, wherein the local area network comprises a satellite uplink network.

5. The method of claim 2, wherein the personal area communication network comprises a Bluetooth network, a ZigBee network, a 802.15.4 network, and/or a Near Field Communication network.

6. The method of claim 1, further comprising remotely monitoring the device after power up.

7. The method of claim 1, further comprising remotely controlling the device after power up.

8. The method of claim 1, further comprising remotely actuating or de-actuating the device after power up.

9. The method of claim 1, wherein the optically scannable identification label comprises a QR code.

10. The method of claim 1, wherein the optically scannable identification label comprises Microsoft TAG.

11. The method of claim 1, wherein the mobile device comprises a smartphone.

12. A method for actuating and/or controlling a remotely located device using a remote mobile device having internet access and optical scanning capability, comprising:
manufacturing a device with a network radio modem;
providing provisioning and activation of the device with a communication network provider during the device manufacturing and distribution process wherein the communication network supplier supplies a network from one of the group consisting of: a wide area network, a local area network, a personal area network, and an ethernet network;
providing provisioning of the device with a cloud data services provider during the device manufacturing and distribution process;
remotely locating the device from a user within a device network, the device and device network in operative communication with the communication network supplier and the cloud data services provider;
automatically joining the device with the cloud data services provider and the communication network supplier upon power up by an end user with the mobile device;
obtaining device-specific data for the manufactured device;
embedding the device-specific data obtained on an optically scannable identification label;
attaching the identification label to the manufactured device;
entering the device-specific data in a database;
scanning the identification label with the mobile device to obtain access to the manufactured device and to view data regarding the remotely located device;
using the mobile device, powering up the accessed manufactured device; and
using the mobile device, communicating with the device to activate and/or control the device.

13. The method of claim 12, wherein the wide area communication network comprises a wireless cellular network and/or a satellite uplink network.

13. The method of claim 12, wherein the local area network comprises a wifi network.

14. The method of claim 12, wherein the personal area communication network comprises a Bluetooth network, a ZigBee network, a 802.15.4 network and/or a Near Field Communication network.
